(19) United States
(12) Patent Application Publication
(10) Pub. No.: US 2013/0048763 A1
(43) Pub. Date: Feb. 28, 2013

(54) PRECAST CONCRETE MITERED END SECTION FOR DRAINAGE SYSTEMS

(71) Applicant: Frank David Geores, Dade City, FL (US)

(72) Inventor: Frank David Geores, Dade City, FL (US)

(21) Appl. No.: 13/479,267

(22) Filed: May 23, 2012

Related U.S. Application Data
(60) Provisional application No. 61/526,768, filed on Aug. 24, 2011.

(51) Int. Cl. B05B 1/00; B23P 17/04

(52) U.S. Cl. 239/589; 29/428

(57) ABSTRACT

A precast concrete mitered end section for drainage systems eliminates the conventional cut pipe and poured in place concrete apron. The precast concrete mitered end section is a structure that eliminates the waste of culvert pipe and is a superior product compared to a poured in place apron. Moreover, installation is fast and cheaper than the conventional methods. The mitered end section can include a resilient seal that can provide a water tight connection and allow for settlement.

### CROSS-REFERENCE TO RELATED APPLICATIONS

This application claims the benefit of priority of U.S. provisional patent application No. 61/526,768, filed Aug. 24, 2011, the contents of which are herein incorporated by reference.

### BACKGROUND OF THE INVENTION

The present invention relates to drainage systems and, more particularly, to a precast concrete mitered end section and method of use thereof for drainage systems.

A conventional mitered end section is a tapered pipe with a concrete, poured in place apron. These mitered end sections are commonly used in drainage systems.

Conventional methods to construct these mitered end sections involves delays, high cost and waste materials. Moreover, there are public safety risks associated with the methods for conventional mitered end sections with poured in place aprons, as the area being worked on may need to be left open for several days for concrete to cure and inspections to take place.

Often, the finished end product of conventional mitered end sections is subject to breakage or damage, as the design apron is often formed with non-structural concrete, which has a tendency to break and fall apart over time.

As can be seen, there is a need for an improved mitered end section that overcomes the deficiencies of conventional mitered end sections as described above.

### SUMMARY OF THE INVENTION

In one aspect of the present invention, a precast concrete mitered end section comprises a precast concrete body having a mitered face; and a drain pipe connection opposite the mitered face, wherein the precast concrete body is formed and cured prior to installation at a desired location.

In another aspect of the present invention, a method for installing a drainage end section comprises preparing an area to the proper elevation for placement of a precast concrete mitered end section, the mitered end section having a precast concrete body having a mitered face and a drain pipe connection opposite the mitered face, wherein the precast concrete body is formed and cured prior to installation at a desired location; placing the mitered end section at the prepared area; and installing a drainage pipe into the drain pipe connection.

These and other features, aspects and advantages of the present invention will become better understood with reference to the following drawings, description and claims.

### BRIEF DESCRIPTION OF THE DRAWINGS

FIG. 1 is a partially cut-away perspective view of a mitered end section according to an exemplary embodiment of the present invention;

FIG. 2 is a front end perspective view of the mitered end section of FIG. 1;

FIG. 3 is a rear end perspective view of the mitered end section of FIG. 1;

FIG. 4 is a side view of the mitered end section of FIG. 1;

FIG. 5 is a back view of the mitered end section of FIG. 1;

FIG. 6 is a cross-sectional view taken along line 6-6 of FIG. 1; and

FIG. 7 is a flow chart describing a process for using of the mitered end section of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a precast concrete mitered end section for drainage systems that eliminates the conventional cut pipe and poured in place concrete apron. The precast concrete mitered end section of the present invention is a structure that eliminates the waste of culvert pipe and is a superior product compared to a poured in place apron. Moreover, installation is fast and cheaper than the conventional methods. The mitered end section can include a resilient seal that can provide a water tight connection and allow for settlement.

The precast mitered end section of the present invention can be manufactured under a quality control plan and its design eliminates the waste of culvert pipe. Installation is completed in minutes, rather than in days, and delays for inspection can be avoided. Furthermore, the need for maintenance of traffic around the installation is reduced, improving public safety. The mitered end section of the present invention is approved by the Department of Transportation and accomplishes the intent of existing Department of Transportation specifications while eliminating waste, improving quality and reducing safety risks.

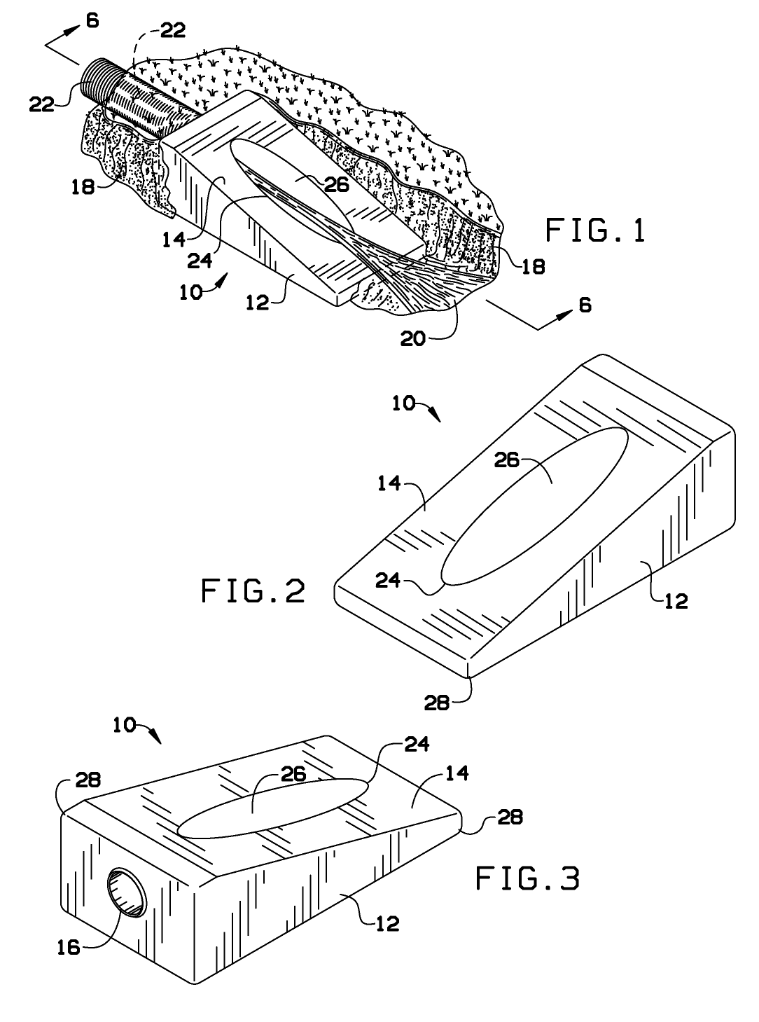

Referring now to FIGS. 1 through 6, a mitered end section 10 includes a concrete body 12 and a mitered face 14. A resilient connector seal 16 may be disposed on a pipe connection end of the mitered end section 10. This seal 16 may be compliant with, for example, Department of Transportation standards, but also may be optionally included, depending upon the specific application. A drain pipe 22 may connect with the seal 16, as shown in FIG. 1, for example.

The mitered face 14 may provide a drainage port 24 along a drainage shaft 26 formed through the mitered end section 10. The drainage shaft may permit the flow of water 20 through the mitered end section 10.

A bullnose corner 28 may be provided at the interface of the pipe connection side of the mitered end section 10 and a top portion of the mitered face 14. The bullnose corner 28 may assist in, for example, grading around an installed mitered end section 10.

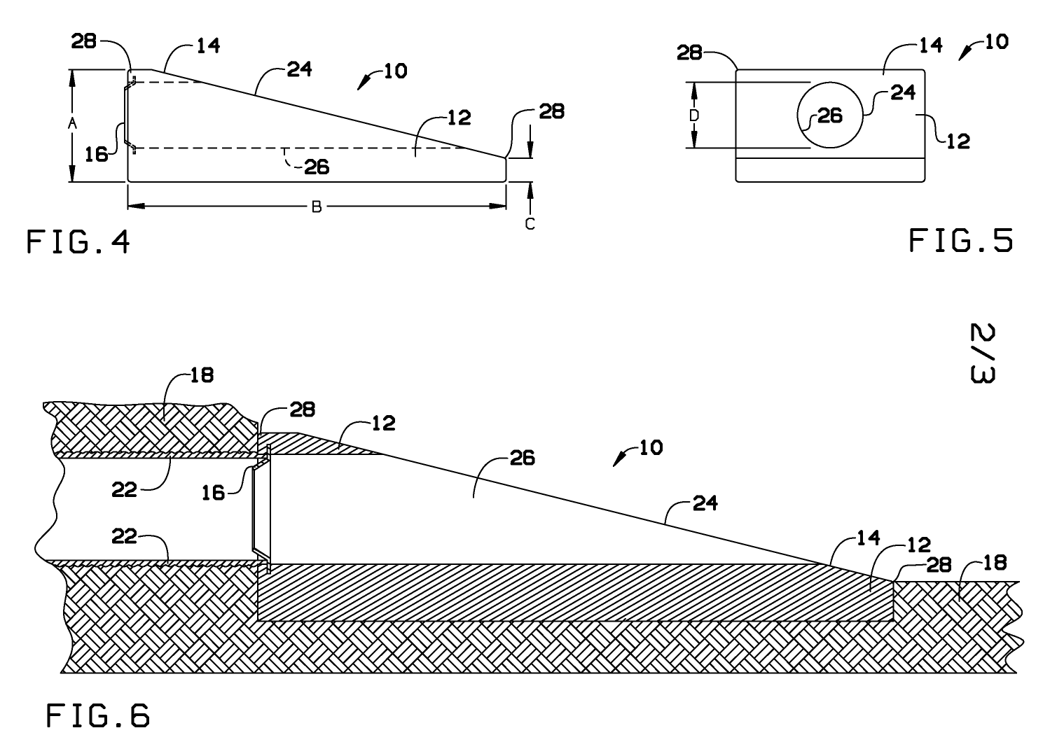

The mitered end section 10 may be formed in various sizes. Referring to FIGS. 4 and 5, the drainage shaft 26 may be formed from about 3 to about 10 inches, typically about 6 inches from the bottom of the mitered end section 10. This dimension is labeled as “C” in FIG. 4. The drainage shaft 26 may have a diameter “D” (FIG. 5) from about 8 inches to about 30 inches, or greater, typically from about 12 to about 30 inches. The slope of the mitered face 14 (run “B” over rise “A” in FIG. 4) may be from about 2:1 to about 6:1, typically the slope will be about 2:1, where the diameter “D” of the drainage shaft 26 is 30 inches or greater, and 4:1 where the diameter “D” of the drainage shaft 26 is 24 inches or less. The mitered end section 10 may include various optional components, such as a grate affixed to the mitered end section 10 or a gate to control the flow therethrough.

The mitered end section can be monolithically poured and shaped in such a manner to permit drainage through the product without using pipe in the portion of the system that is not underground. Reinforcement materials permit the structure to be much stronger than the current poured in place products. Quality controlled manufacturing processes provide uniform products superior to current methods in function, structural integrity, durability with the additional feature of reuse and or relocation.

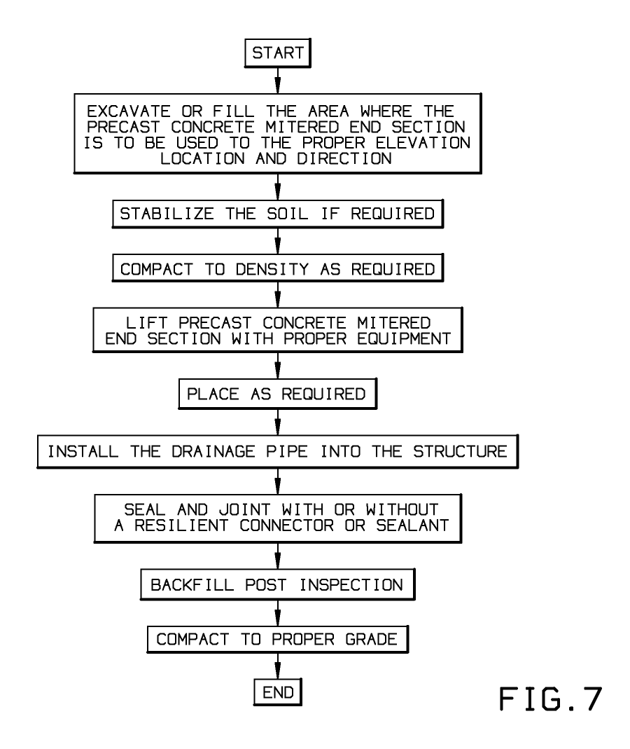

Referring to FIG. 7, to use the mitered end section 10 of the present invention, a user can first excavate the earth 18 or fill the area where the product is to be used to the proper elevation, location and direction, stabilize the soil if required, compact to density required and lift the product with proper equipment place as required. Next, the user can install the drainage pipe 22 into the structure and seal the joint with or without a resilient connector 16 or sealant (type of connection, as required). After inspection, the user can backfill and compact the earth 18 to proper grade.

Although the present invention is illustratively demonstrated with specific proportions with respect to dimensional specifications A, B, C and D as shown in FIGS. 4 and 5, it should be stated and understood that the totality and scope of the invention encompasses any and all variations of these dimensional specifications, that the foregoing configuration relates to an exemplary embodiment of the invention and that modifications in component configuration, design and even usage may be made without departing from the spirit and scope of the invention as set forth in the following and subsequent claim(s) and by those knowledgeable in drainage system construction arts.

It should be understood, of course, that the foregoing relates to exemplary embodiments of the invention and that modifications may be made without departing from the spirit and scope of the invention as set forth in the following claims.

What is claimed is:

1. A precast concrete mitered end section comprising:
a precast concrete body having a mitered face; and
a drain pipe connection opposite the mitered face, wherein
the precast concrete body is formed and cured prior to installation at a desired location.

2. The precast concrete mitered end section of claim 1, further comprising a resilient connector seal formed at the drain pipe connection in the precast concrete body and adapted to receive a drain pipe.

3. The precast concrete mitered end section of claim 1, where the mitered face has a slope from about 2:1 to about 4:1.

4. The precast concrete mitered end section of claim 1, further comprising a drainage shaft passing through the precast concrete body, the drainage shaft having a diameter from about 12 inches to about 30 inches.

5. The precast concrete mitered end section of claim 4, wherein the drainage shaft is disposed about 6 inches from a bottom side of the precast concrete body.

6. The precast concrete mitered end section of claim 1, further comprising a bullnose edge formed on a corner of a top edge of the mitered face and an adjacent side of the precast concrete body.

7. A method for installing a drainage end section, the method comprising:
preparing an area to the proper elevation for placement of a precast concrete mitered end section, the mitered end section having a precast concrete body having a mitered face and a drain pipe connection opposite the mitered face, wherein the precast concrete body is formed and cured prior to installation at a desired location;
placing the mitered end section at the prepared area; and
installing a drainage pipe into the drain pipe connection.

8. The method of claim 7, further comprising stabilizing and compacting the area as needed prior to placing the mitered end section at the prepared area.

9. The method of claim 7, further comprising sealing the drain pipe into the drain pipe connection with a resilient connector seal.

10. The method of claim 7, further comprising backfilling an area around the mitered end section and grading to a desired grade.
